(19) United States
(12) Patent Application Publication
(10) Pub. No.: US 2026/0205447 A1
(43) Pub. Date: Jul. 16, 2026

(54) ENCRYPTION SELECTION

(71) Applicant: British Telecommunications Public Limited Company, London Greater London (GB)

(72) Inventors: Ali SAJJAD, London Greater London (GB); Fadi EL-MOUSSA, London Greater London (GB)

(21) Appl. No.: 19/138,556

(22) PCT Filed: Dec. 8, 2023
(86) PCT No.: PCT/EP2023/084917

§ 371 Date: Jun. 12, 2025

(30) Foreign Application Priority Data
Dec. 16, 2022 (EP) 22214140.0
Dec. 16, 2022 (GB) 2219032.6

(51) Int. Cl. H04L 9/40

(52) U.S. Cl. CPC H04L 63/0428; H04L 63/029; H04L 63/205

(57) ABSTRACT

A computer-implemented method of encrypting internet of things (IoT) device data communications is disclosed. The method involves transmitting network data having a predetermined pattern of network packets from a network apparatus to the IoT device. Network response behaviour of the IoT device to the network data is analysed to ascertain one or more performance characteristics of the IoT device. An encryption algorithm for the data communications is selected based on the ascertained one or more performance characteristics. The data communications are then encrypted using the selected encryption algorithm.

### FIELD OF THE INVENTION

The present disclosure relates to the selection of encryption algorithms for Internet of Things devices.

### BACKGROUND

Many Internet of Things (IoT) devices are constrained in terms of processing power, memory capacity, networking performance and/or battery life. As a consequence, the performance of these IoT devices can be adversely affected if unsuitable cryptographic algorithms are used to protect data communications.

For example, if a cryptosystem based on heavy-weight encryption techniques such as 3DES or 256-bit AEAD (Authenticated Encryption with Additional Data) is used, it will consume significant computational and memory resources of the IoT device even though the device may not actually require such a high level of security. On the other hand, if a cryptosystem based on light-weight techniques like Salsa or LFSR is used, the security level may not be sufficient for the data being communicated.

Selection of suitable encryption algorithms ideally requires knowledge of the hardware capabilities of the devices involved. However, most IoT devices provide limited or no access for third parties to obtain this information. In particular, it is often difficult or impossible for a third-party to access the IoT device and determine basic information such as CPU specification and memory capacity.

Consequently, it can be difficult for third parties and third-party equipment (such as network access points) to select appropriate encryption schemes.

### SUMMARY OF THE INVENTION

According to a first aspect, there is provided a network apparatus configured to: transmit network data to an internet of things (IoT) device, wherein the network data has a predetermined pattern of network packets; analyse network response behaviour of the IoT device to the network data to ascertain one or more performance characteristics of the IoT device; select an encryption algorithm for data communications with the IoT device based on the ascertained one or more performance characteristics; and cause the data communications to be encrypted using the selected encryption algorithm.

According to a second aspect, there is provided a computer-implemented method of encrypting internet of things (IoT) device data communications, the method comprising: transmitting network data from a network apparatus to the IoT device, wherein the network data has a predetermined pattern of network packets; analysing network response behaviour of the IoT device to the network data to ascertain one or more performance characteristics of the IoT device; selecting an encryption algorithm for the data communications based on the ascertained one or more performance characteristics; and encrypting the data communications using the selected encryption algorithm.

Device response behaviour (e.g. latency, which is the time taken for the IoT device to respond to the transmitted network data) varies depending upon (i) device performance characteristics (i.e. device capabilities such as memory/processing capabilities), and (ii) the network data being responded to (e.g. latency may increase when the packet size and/or packet frequency becomes too large for the device to handle). This is particularly relevant for IoT devices, which generally have relatively limited capabilities.

The present invention allows network apparatus (such as access points) to infer device performance characteristics even when device specifications are not provided by the IoT device vendor. The inferred performance characteristics can then be used to select the most appropriate encryption protocol for a device having those characteristics (e.g. using a lookup table, decision tree or machine learning classifier etc).

One skilled in the art will appreciate that there are various ways in which the predetermined pattern of network packets could be shaped (e.g. transmitting network data having multiple distinct packet sizes and/or multiple distinct packet frequencies), and that there are various ways in which the network response behaviour can be analysed (e.g. measuring a latency associated with the time taken for the IoT device to respond to the shaped network packets). When a latency is measured, it should be understood that latency measurements can include timeout measurements whereby the IoT device does not respond within a predetermined maximum duration.

Communications may be via a wired or wireless link. The network apparatus may be any suitable network hardware, such as an access point or a network interface controller.

Selecting an encryption algorithm may involve selecting an encryption algorithm for a particular protocol (e.g. even if the protocol is fixed on the IoT device, such as if the IoT device can only use HTTPS, an encryption algorithm can still be selected from the encryption algorithms within that protocol).

Transmitting network data may comprise transmitting a plurality of network packets having varying packet sizes (i.e. at least one network packet may be transmitted for each of a plurality of distinct packet sizes). Analysing network response behaviour may comprise measuring a response latency associated with each packet size (when multiple network packets are transmitted for each network packet size, this may optionally be an average response latency associated with the network packets of that network packet size) and determining an estimated memory capability (e.g. available memory size/memory capacity) of the IoT device based on the response latency associated with each packet size (i.e. by identifying a correlation between network packet size and latency or by identifying the maximum packet size achievable without the IoT device timing out). The encryption algorithm may be selected based on the estimated memory capability.

Transmitting network data may additionally/alternatively comprise transmitting network packets at a plurality of transmission rates. Analysing network response behaviour may comprises measuring a response latency associated with each transmission rate (this may optionally be an average latency associated with a particular transmission rate) and determining an estimated processing capability (e.g. CPU frequency, CPU FLOPs (floating point operations per second) measure and/or number of CPU cores) of the IoT device based on the response latency associated with each transmission rate (i.e. by identifying a correlation between transmission rate and latency or by identifying the maximum transmission rate achievable without the IoT device timing out). The encryption algorithm may be selected based on the estimated processing capability.

Response latency is the time taken between transmitting the network data from the network apparatus to the IoT device and receiving a corresponding response from the IoT device at the network apparatus.

The estimated processing capability may optionally comprise one or more of a processor frequency, processor performance and number of processing cores.

Ascertaining the one or more performance characteristics may optionally comprise using a performance characteristic lookup table to ascertain the one or more performance characteristics based on the network response behaviour of the IoT device. Alternatively, ascertaining the one or more performance characteristics may comprise using a trained classifier (e.g. a machine learning classifier or a predictive model) to ascertain the one or more performance characteristics based on the network response behaviour of the IoT device.

Selecting the encryption algorithm may comprise selecting an encryption algorithm from a plurality of candidate encryption algorithms. The selected encryption algorithm may be the most secure candidate encryption algorithm (i.e. the candidate encryption algorithm with the highest security level, e.g. expressed in bits of security or using any other suitable security rating known to a person skilled in the art), capable of being performed by the IoT device (i.e. capable of being performed without compromising normal functioning of the IoT device) according to the ascertained one or more performance characteristics. Selecting such an encryption algorithm allows security to be optimised without compromising device performance.

Selecting the encryption algorithm may comprise selecting an encryption algorithm from an encryption algorithm lookup table based on the ascertained one or more performance characteristics. Alternatively, selecting the encryption algorithm may comprise using a decision tree to select the algorithm based on the ascertained one or more performance characteristics.

The network apparatus may act as a bridge or proxy between the IoT device and another device (e.g. another device on the same network or another device on the Internet) by establishing a secure tunnel between the IoT device and the other device (e.g. an IPsec bridge or TLS proxy).

Data communications of the other device may optionally be encrypted with another encryption algorithm that is different to the encryption algorithm used to encrypt data communications of the IoT device.

The apparatus may optionally be an access point. For example, the network apparatus may be a network router (e.g. a Wi-Fi router and/or modem), and the data communications may be over a local area network (LAN). It is generally possible to measure network response behaviour (e.g. latency) more accurately and consistently on a LAN than on larger networks such as WANs, so the present invention is particularly well suited to use on a LAN (e.g. in a home or business/corporate environment). Network routers may be fully managed by an end-user or an internet service provider and have sufficient computational and memory resources to run a wide range of cryptographic algorithms and protocols.

According to a third aspect, there is provided a computer program comprising instructions which, when executed by a computer, cause the computer to carry out the method steps of the second aspect.

According to a fourth aspect, there is provided a computer readable carrier medium comprising the computer program of the third aspect.

### BRIEF DESCRIPTION OF THE FIGURES

Aspects of the present disclosure will now be described by way of example with reference to the accompanying figures, in which:

FIG. 1 is a schematic of a data processing apparatus;

FIG. 2 is a schematic of a network access point in communication with an Internet of Things device;

FIG. 3 is an example decision tree for selecting an encryption algorithm;

FIG. 4 is a schematic of a network access point in communication with two Internet of Things devices and the Internet; and

FIG. 5 is a flowchart of a method for selecting an encryption algorithm.

### DETAILED DESCRIPTION

An Internet of Things (IoT) device is typically a non-standard computing device that can connect, often wirelessly, to a network and can transmit and receive data on that network. IoT devices include smart TVs, smart speakers, CCTV cameras, smart thermostats, wearables, smart appliances etc. These devices often have limited processing, memory, networking, power and/or security capabilities and are generally configured and managed through a vendor-specific software application or an integrated web server. Most desktops, laptops, smartphones and tablets etc. are not IoT devices.

IoT devices are often supplied with inadequate default network security provisions. This can result in the data that is transmitted and received by these devices being exposed to potential attackers. While the resulting security risks can be mitigated through the use of suitable encryption techniques, determining the correct encryption algorithm to use can be difficult unless the encryption provider either (a) has access to hardware specifications for the IoT device, or (b) has the ability to install/modify software on the IoT device (which is not generally the case).

Selecting an encryption protocol that is too “lightweight” risks needlessly exposing network traffic to potential attackers. Selecting an encryption protocol that is too “heavyweight” (i.e. too performance-intensive) risks overwhelming (and potentially crashing) the IoT device.

As set out in Kartik Pandit et. al., “Modeling the impact of CPU properties to optimize and predict packet-processing performance”, packet processing performance of a computing device scales linearly with the number of cores in the CPU, and also scales linearly with the CPU frequency. While the authors of the paper had prior knowledge of the specifications of the computing devices in question, the present inventors have recognised that similar relationships can be used to infer performance characteristics for devices where the specifications are not known.

In particular, an IoT device can be probed with shaped network traffic to ascertain performance characteristics of the device (in particular, the device's processing capability and memory availability). For example, flooding the IoT device with packets of increasing sizes and analysing its responses gives an indication of memory capacity, whereas flooding the IoT device with an increasing quantity/rate of packets and analysing its responses gives an indication of processing power.

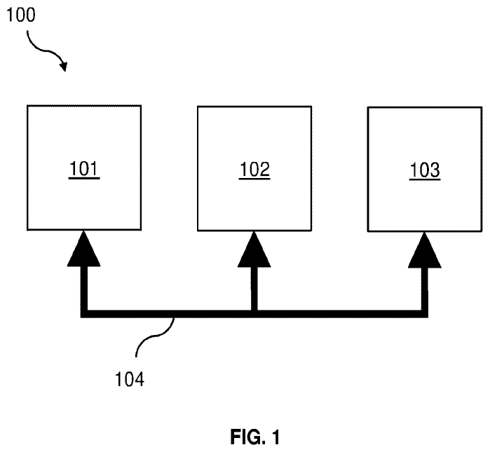

FIG. 1 schematically illustrates an example of a data processing apparatus capable of performing any of the methods described herein. It comprises a processor 101 operably coupled to both a memory 102 and an interface (I/O) 103 via a bus 104.

The memory 102 may optionally comprise computer program instructions which, when the program is executed by the processor 101, cause the data processing apparatus 100 to carry out any of the methods described herein. Alternatively or additionally, the interface 103 can optionally comprise one or both of a physical interface configured to receive a data carrier having such instructions stored thereon and a receiver configured to receive a data carrier signal carrying such instructions.

The receiver, when present, can be configured to receive messages. It can comprise one or more wireless receiver modules and/or one or more wired receiver modules. The interface 103 can optionally comprise a transmitter configured to transmit messages. The transmitter, when present, can comprise one or more wireless transmitter modules and/or one or more wired transmitter modules.

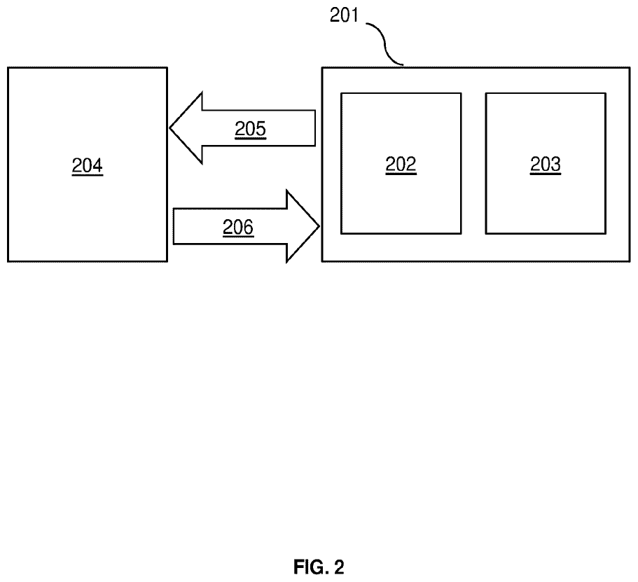

The data processing apparatus 100 may be (or may be part of) a network apparatus such as an access point. FIG. 2 shows a schematic of an access point 201 in communication with an IoT device 204. The illustrated access point 201 acts as an encryption proxy that enforces an encryption algorithm to be used for all communications between the access point 201 and the IoT device 204.

The access point 201 comprises a flooder module 202 and a decision analysis module 203, which may each be embodied in various forms, such as software, firmware and/or hardware.

The flooder module 202 is adapted to transmit shaped network traffic 205 having a predetermined pattern of network packets to the IoT device 204 to probe the IoT device 204. For example, the shaped network traffic 205 may be formed of a series of packets (or a series of groups of packets) having increasing packet sizes in order to probe memory capabilities of the IoT device 204. Alternatively, the shaped network traffic 205 may be formed of a series of packet bursts (or a series of groups of packet bursts) having increasing packet transmission rates in order to probe processing capabilities of the IoT device 204.

The flooder module 202 then receives response traffic 206 from the IoT device 204 and measures a latency associated with each packet/packet burst. If the latency exceeds a predetermined maximum expected latency, then the measurement will be considered to be a timeout (i.e. non-response).

The decision analysis module 203 then analyses correlations between the attributes of the shaped network traffic 205 (i.e. packet size or transmission rate) and the associated latency (or average latency) measured for each attribute in order to determine performance characteristics of the IoT device 204.

In general, larger packets sizes will eventually lead to increased latency in the response traffic 206, thereby indicating that the IoT device 204 is operating at the limit of its memory capabilities. Similarly, greater transmission rates will likewise eventually lead to increased latency in the response traffic 206, thereby indicating that the IoT device 204 is operating at the limit of its processing capabilities. Performance characteristics of the IoT device can be inferred/ascertained using various techniques including lookup tables and machine learning algorithms that have been trained using training data generated by probing IoT devices that have known hardware specifications.

Once the performance characteristics of the IoT device 204 have been inferred, the decision analysis module 203 proceeds to select an encryption algorithm to be used for communications between the access point 201 and the IoT device 204. This may again be achieved using various techniques such as lookup tables, machine learning algorithms or decisions trees.

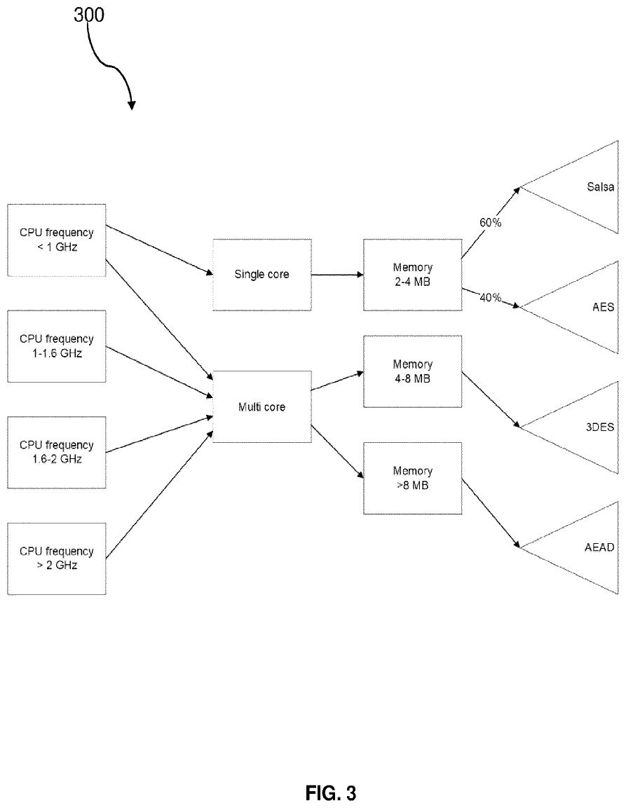

An example of a decision tree 300 is shown in FIG. 3. The inferred performance characteristics can be used to select from various encryption algorithms using the decision tree 300. In the illustrated decision tree 300, Salsa and AES are both considered to be appropriate for single core IoT devices having a CPU frequency of less than 1 GHz and between 2-4 MB memory, so the decision tree indicates that Salsa should be chosen in 60% of these cases and AES should be selected it the remaining 40%. It should be understood that the decision tree 300 in FIG. 3 is merely given as an example and that one skilled in the art would readily be able to select encryption algorithms that are suitable for devices having different performance capabilities in order to generate decision trees as appropriate.

The selected encryption algorithm will preferably be the most secure algorithm that can be implemented by a device with the ascertained performance characteristics (i.e. the most secure encryption algorithm that does not have a detrimental impact upon normal functioning of the IoT device 204).

Once a suitable encryption algorithm has been selected, the access point 201 can start a proxy service that acts as a transparent intermediary between the IoT device 204 and any other devices (either local or remote) by establishing IPsec or TLS (Transport Layer Security) tunnels between the devices.

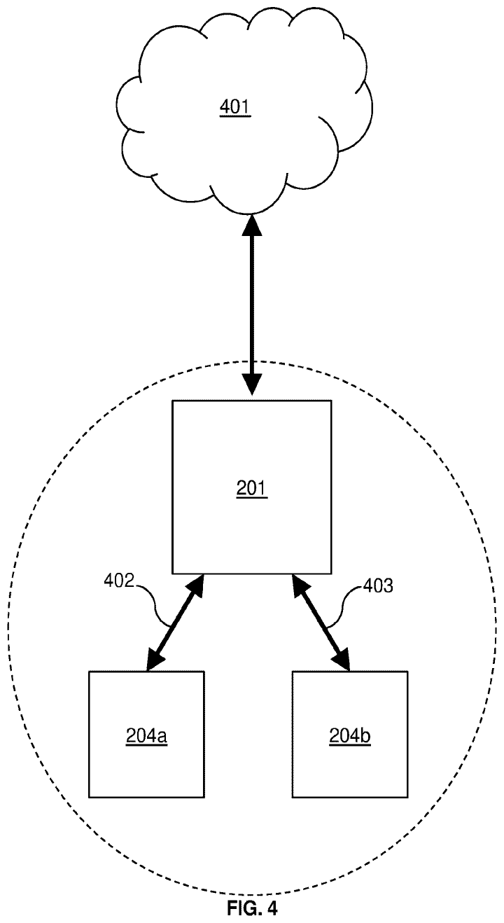

For example, as shown in FIG. 4, the access point 201 may be in communication with a first IoT device 204a and a second IoT device 204b and with devices on the Internet 401 (such as a cloud-hosted backend in communication with the IoT devices 204a, 204b).

Communications 402 between the access point 201 and the first IoT device 204a may be encrypted using a first encryption method (e.g. a TLS connection using 3DES), and communications 403 between the access point 201 and the second IoT device 204b may be encrypted using a second encryption method (e.g. a TLS connection using AES). The access point 201 then acts as a proxy service that establishes a logical bridge between the IoT devices 204a, 204b and allows all communication between the IoT devices 204a, 204b (and between the IoT devices 204a, 204b and the Internet 401) to be encrypted/decrypted using the chosen encryption methods, which can be different for each device because the actual TCP or HTTP session is only between an individual device and the access point 201.

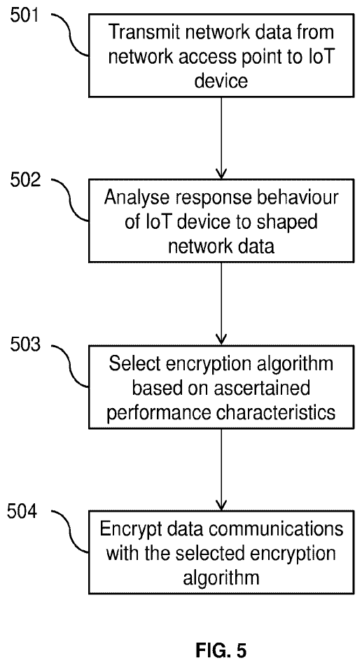

FIG. 5 shows a flowchart of a method for selecting an encryption algorithm according to the present invention as described above.

At step 501, network data having a predetermined pattern of network packets is transmitted from the access point 201 to the IoT device 204.

At step 502, the access point 201 receives a response from the IoT device 204 (unless the IoT device 204 fails to respond, in which case the respond will be recorded as a timeout) and analyses the network response behaviour of the IoT device 204 to the shaped network data to ascertain one or more performance characteristics of the IoT device 204 (such as memory and processing capability). It should be understood that the ascertained performance characteristics are indicative of the actual performance characteristics of the IoT device 204 (i.e. they are estimations of the actual hardware specification of the IoT device 204).

At step 503, the access point 201 uses the ascertained performance characteristics to select a suitable encryption algorithm for data communications between the IoT device 204 and the access point 201 (e.g. using a lookup table or by any other suitable technique).

At step 504, the access point 201 uses the selected encryption algorithm to encrypt all communications between the access point 201 and the IoT device 204. Using the method of FIG. 5 ensures that an appropriate encryption algorithm is selected for the IoT device 204 and prevents the selection of an encryption algorithm that the IoT device 204 is not capable of implementing (attempting to implement such an algorithm could potentially cause the IoT device 204 to become unresponsive, which may require user intervention to restart the IoT device 204).

While all steps of the method in FIG. 5 are performed by the access point, it should be understood that some or all of the steps could alternatively be performed by an alternative network apparatus/device. For example, the method could be performed using a wired or wireless network interface controller, a router, a gateway etc.

The preceding description is presented to enable any person skilled in the art to make and use the system and/or perform the method of the invention and is provided in the context of a particular application. Various modifications to the disclosed examples will be readily apparent to those skilled in the art. It is intended that the specification be considered as exemplary only.

Where this specification lists one or more method steps, the presence of precursor, follow-on and intervening method steps is not excluded unless such exclusion is explicitly indicated. Similarly, where this specification lists one or more components of a device or system, the presence of additional components, whether separate or intervening, is not excluded unless such exclusion is explicitly indicated.

In addition, where this specification has listed the steps of a method or procedure in a specific order, it could be possible, or even expedient in certain circumstances, to change the order in which some steps are performed, and it is intended that the particular steps of the method or procedure claims set forth herein not be construed as being order-specific unless such order specificity is expressly stated in the claims. That is, the operations/steps may be performed in any technically feasible order, unless otherwise specified, and methods may include additional or fewer operations/steps than those disclosed herein. It is further contemplated that executing or performing a particular operation/step before, partially or entirely contemporaneously with, or after another operation is in accordance with the described examples.

Insofar as embodiments of the invention described are implementable, at least in part, using a software-controlled programmable processing device, such as a microprocessor, digital signal processor or other processing device, data processing apparatus or system, it will be appreciated that a computer program for configuring a programmable device, apparatus or system to implement the foregoing described methods is envisaged as an aspect of the present invention. Such a computer program may be embodied as source code or undergo compilation for implementation on a processing device, apparatus or system or may be embodied as object code, for example.

Such a computer program may be encoded as executable instructions embodied in a carrier medium, non-transitory computer-readable storage device and/or a memory device in machine or device readable form, for example in volatile memory, non-volatile memory, solid-state memory, magnetic memory such as disk or tape, optically or magneto-optically readable memory such as magnetic tape, compact disk (CD), digital versatile disk (DVD) or other media that are capable of storing code and/or data. Such a computer program may alternatively or additionally be supplied from a remote source embodied in a communications medium such as an electronic signal, radio frequency carrier wave or optical carrier wave. Such carrier media are also envisaged as aspects of the present invention.

Such instructions, when executed by a processor (or one or more computers, processors, and/or other devices) may cause the processor (the one or more computers, processors, and/or other devices) to perform at least a portion of the methods described herein.

Where a processor is referred to herein, this is to be understood to refer to a single processor or multiple processors operably connected to one another. Similarly, where a memory is referred to herein, this is to be understood to refer to a single memory or multiple memories operably connected to one another.

The methods and processes can also be partially or fully embodied in hardware modules or apparatuses or firmware, so that when the hardware modules or apparatuses are activated, they perform the associated methods and processes. The methods and processes can be embodied using a combination of code, data, and hardware modules or apparatuses.

Examples of processing systems, environments, and/or configurations that may be suitable for use with the embodiments described herein include, but are not limited to, embedded computer devices, personal computers, server computers (specific or cloud (virtual) servers), hand-held or laptop devices, multiprocessor systems, microprocessor-based systems, set top boxes, programmable consumer electronics, mobile telephones, smartphones, tablets, network personal computers (PCs), minicomputers, mainframe computers, distributed computing environments that include any of the above systems or devices, and the like. Hardware modules or apparatuses described in this disclosure include, but are not limited to, application-specific integrated circuits (ASICs), field-programmable gate arrays (FPGAs), dedicated or shared processors, and/or other hardware modules or apparatuses.

User devices can include, without limitation, static user devices such as PCs and mobile user devices such as smartphones, tablets, laptops and smartwatches.

Receivers and transmitters as described herein may be standalone or may be comprised in transceivers. A communication link as described herein comprises at least one transmitter capable of transmitting data to at least one receiver over one or more wired or wireless communication channels. Wired communication channels can be arranged for electrical or optical transmission. Such a communication link can optionally further comprise one or more relaying transceivers.

User input devices can include, without limitation, microphones, buttons, keypads, touchscreens, touchpads, trackballs, joysticks, mice, gesture control devices and brain control (e.g. electroencephalography, EEG) devices. User output devices can include, without limitation, speakers, buzzers, display screens, projectors, indicator lights, haptic feedback devices and refreshable braille displays. User interface devices can comprise one or more user input devices, one or more user output devices, or both.

1. A network apparatus configured to:
transmit network data to an internet of things (IoT) device, wherein the network data has a predetermined pattern of network packets;
analyse network response behaviour of the IoT device to the network data to ascertain one or more performance characteristics of the IoT device;
select an encryption algorithm for data communications with the IoT device based on the ascertained one or more performance characteristics; and
cause the data communications to be encrypted using the selected encryption algorithm.

2. A computer-implemented method of encrypting internet of things (IoT) device data communications, the method comprising:
transmitting network data from a network apparatus to the IoT device, wherein the network data has a predetermined pattern of network packets;
analysing network response behaviour of the IoT device to the network data to ascertain one or more performance characteristics of the IoT device;
selecting an encryption algorithm for the data communications based on the ascertained one or more performance characteristics; and
encrypting the data communications using the selected encryption algorithm.

3. The network apparatus or method of claim 1, wherein transmitting network data comprises transmitting a plurality of network packets having varying packet sizes,
wherein analysing network response behaviour comprises measuring a response latency associated with each packet size and determining an estimated memory capability of the IoT device based on the response latency associated with each packet size, and
wherein the encryption algorithm is selected based on the estimated memory capability.

4. The network apparatus or method of claim 1,
wherein transmitting network data comprises transmitting network packets at a plurality of transmission rates,
wherein analysing network response behaviour comprises measuring a response latency associated with each transmission rate and determining an estimated processing capability of the IoT device based on the response latency associated with each transmission rate, and
wherein the encryption algorithm is selected based on the estimated processing capability.

5. The network apparatus or method of claim 4, wherein the estimated processing capability comprises one or more of a processor frequency, processor performance and number of processing cores.

6. The network apparatus or method of claim 1, wherein ascertaining the one or more performance characteristics comprises using a performance characteristic lookup table to ascertain the one or more performance characteristics based on the network response behaviour of the IoT device.

7. The network apparatus or method of claim 1, wherein ascertaining the one or more performance characteristics comprises using a trained classifier to ascertain the one or more performance characteristics based on the network response behaviour of the IoT device.

8. The network apparatus or method of claim 1, wherein selecting the encryption algorithm comprises selecting an encryption algorithm from a plurality of candidate encryption algorithms, wherein the selected encryption algorithm is the candidate encryption algorithm having the highest security level capable of being performed by the IoT device according to the ascertained one or more performance characteristics.

9. The network apparatus or method of claim 1, wherein selecting the encryption algorithm comprises selecting an encryption algorithm from an encryption algorithm lookup table based on the ascertained one or more performance characteristics.

10. The network apparatus or method of claim 1, wherein selecting the encryption algorithm comprises using a decision tree to select the algorithm based on the ascertained one or more performance characteristics.

11. The network apparatus or method of claim 1, wherein the network apparatus acts as a bridge or proxy between the IoT device and another device by establishing a secure tunnel between the IoT device and the other device.

12. The network apparatus or method of claim 11, wherein data communications of the other device are encrypted with another encryption algorithm that is different to the encryption algorithm used to encrypt data communications of the IoT device.

13. The network apparatus or method of claim 1, wherein the network apparatus is a network router, and wherein the data communications are over a local area network (LAN).

14. A computer program comprising instructions which, when executed by a computer, cause the computer to carry out the method steps of claim 2.

15. A computer readable carrier medium comprising the computer program of claim 14.
